(19) United States
(12) Patent Application Publication
(10) Pub. No.: US 2009/0015407 A1
(43) Pub. Date: Jan. 15, 2009

(54) RIFID TAGS AND METHODS OF DESIGNING RFID TAGS

(75) Inventor: John R. Tuttle, Boulder, CO (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: MICRON TECHNOLOGY, INC., BOISE, ID (US)

(21) Appl. No.: 11/777,843

(22) Filed: Jul. 13, 2007

(51) Int. Cl. G08B 13/14; H01Q 1/50

(52) U.S. Cl. 340/572.1; 343/860

(57) ABSTRACT

RFID tags and methods of designing RFID tags. At least some of the illustrative embodiments are RFID tags comprising a tag antenna, a matching circuit coupled to the tag antenna, a shorting device coupled to the tag antenna and the matching circuit (wherein the shorting device is configured to selectively couple the tag antenna to common), and a tag circuit coupled to the matching circuit and the shorting device (the tag circuit configured to control the shorting device). In one or more such embodiments, a difference between a reflection coefficient of the tag antenna when the shorting device is conductive and a reflection coefficient of the tag antenna when shorting device is non-conductive is greater than or equal to approximately 0.8.

### BACKGROUND

1. Field

This disclosure is directed to radio frequency identification (RFID) tags, and more particularly, in one or more embodiments, relationships between shorting devices and tag antennas of RFID tags.

2. Description of the Related Art

Semi-active and passive RFID tags communicate with a RFID reader by way of backscattered radio frequency (RF) signals. In particular, the RFID reader, after commanding a RFID tag to respond, transmits a continuous-wave RF signal. The antenna of the RFID tag is selectively tuned and de-tuned based on the data to be transmitted. The RFID reader thus receives the data in form of reflected (backscattered) signals from the antenna of the RFID tag. Any mechanism that increases the physical range of backscatter-based communications from an RFID tag to a RFID reader, and/or decreases error rate in transmission, is desirable.

### BRIEF DESCRIPTION OF THE DRAWINGS

For a detailed description of various embodiments, reference will now be made to the accompanying drawings in which:

FIG. 1 shows a radio frequency identification (RFID) system in accordance with at least some embodiments;

FIG. 2 shows a RFID tag in greater detail;

FIG. 3 show a RFID tag in accordance with other embodiments; and

FIG. 4 shows a method in accordance with at least some embodiments.

### NOTATION AND NOMENCLATURE

Certain terms are used throughout the following description and claims to refer to particular system components. As one skilled in the art will appreciate, design and manufacturing companies may refer to the same component by different names. This document does not intend to distinguish between components that differ in name but not function. In the following discussion and in the claims, the terms “including” and “comprising” are used in an open-ended fashion, and thus should be interpreted to mean “including, but not limited to . . . . ”

Also, the term “couple” or “couples” is intended to mean either an indirect or direct connection. Thus, if a first device couples to a second device, that connection may be through a direct connection or through an indirect connection via other intermediate devices and connections. Moreover, the term “system” means “one or more components” combined together. Thus, a system can comprise an “entire system,” “subsystems” within the system, a radio frequency identification (RFID) tag, a RFID reader, or any other device comprising one or more components.

The terms “conducting” and “conductive state” with reference to a switch device refer to the impedance across the terminals of the switch device when in a fully conductive state. Thus, though a transistor may be biased at its base (gate) to have a range of impedances across its source/drain (collector/emitter), the conducting and conductive state impedance refer to the impedance across the source/drain (collector/emitter) when the base (gate) is biased substantially to the point of saturation with respect to further source/drain (collector/emitter) impedance changes.

Moreover, the term “impedance” refers a device's opposition to both alternating and direct electric current flow, and the impedance of a device may thus have both real and imaginary (i.e., square root of negative one) components; however, in this specification and in the claims when reference is made to a conducting or conductive state impedance of a device in relation to an impedance of an antenna, only the real portion and/or the magnitude of the impedance is considered.

“Matching”, in reference to a matching circuit coupled to an antenna, shall mean the circuit is constructed to achieve improved power transfer both in and out of the antenna. Matching impedance is, in most cases, the complex conjugate of antenna impedance.

Finally, the term “shorting device” shall refer to any device operable as an electrically controlled switch; however, use of the term “shorting device” shall not imply a direct short (the shorting device having zero impedance) when the shorting device is conducting. Shorting an antenna using a shorting device implies detuning the antenna by shorting the matching circuit.

### DETAILED DESCRIPTION OF DISCLOSED EMBODIMENTS

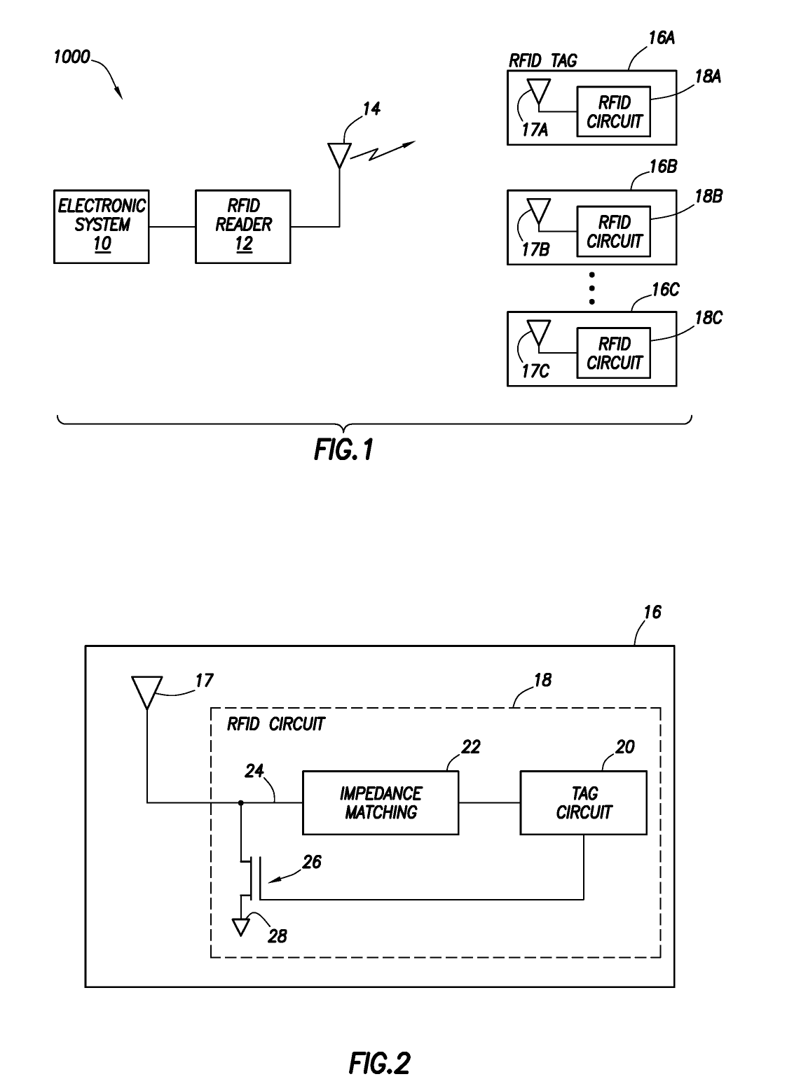

FIG. 1 illustrates a system 1000 in accordance with at least some embodiments. In particular, system 1000 comprises an electronic system 10 (e.g. a computer system) coupled to a radio frequency identification (RFID) reader 12. The RFID reader 12 may be equivalently referred as an interrogator. By way of antenna 14, the RFID reader 12 communicates with one or more RFID tags 16A-16C proximate to the RFID reader (i e., within communication range).

Considering a single RFID tag 16A (but the description equally applicable to all the RFID tags 16), the communication sent by the RFID reader 12 is received by tag antenna 17A, and passed to the RFID circuit 18A. If the communication from the RFID reader triggers a response, the RFID circuit 18 sends to the RFID reader 12 the response (e.g. a tag identification value, or data held in the tag memory) using the tag antenna 17A. The RFID reader 12 passes data obtained from the various RFID tags 16 to the electronic system 10, which performs any suitable function. For example, the electronic system 10, based on the data received from the RFID tags 16, may allow access to a building or parking garage, note the entrance of an employee to a work location, direct a parcel identified by the RFID tag 16 down a particular conveyor system, or track the movement of poultry.

There are several types of RFID tags operable in the illustrative system 1000. For example, RFID tags may be semi-active tags. Semi-active tags have an internal battery or power source, but a semi-active tag remains dormant (i e., powered-off or in a low power state) most of the time. When an antenna of a semi-active tag receives an interrogating signal, the power received is used to wake or activate the semi-active tag, and a response (if any) is sent by modulating the RF backscatter from the tag antenna, with the semi-active tag using power for internal operations from its internal battery or power source. In particular, the RFID reader 12 and antenna 14 continue to transmit power after the RFID tag is awake. While the RFID reader 12 transmits, the tag antenna 17 of the RFID tag 16 is selectively tuned and de-tuned with respect to the carrier frequency. When tuned (e.g. to a length of ½ or ¼ wavelength of the frequency range of interest), significant incident power is absorbed by the tag antenna 17. When de-tuned, significant power is reflected by the tag antenna 17 to the antenna 14 of the RFID reader 12. The RFID reader 12 reads the data or identification value from the backscattered electromagnetic waves. Thus, in this specification and in the claims, the terms “transmitting” and “transmission” include not only sending from an antenna using internally sourced power, but also sending in the form of backscattered signals.

A second type of RFID tag is a passive tag, which, unlike semi-active RFID tags, has no internal battery or power source. The tag antenna 17 of the passive RFID tag receives an interrogating signal from the RFID reader, and the power extracted from the received interrogating signal is used to power the tag. Once powered or “awake,” the passive RFID tag may accept a command, send a response comprising a data or identification value, or both; however, like the semi-active tag the passive tag sends the response in the form of backscattered radio frequency signals.

FIG. 2 shows a more detailed view of the RFID tag 16 in accordance with at least some embodiments. In particular, the RFID tag 17 comprises tag antenna 17 coupled to the tag circuit 20 by way of an impedance matching circuit 22. As the name implies, the impedance matching circuit has impedance (as viewed from input terminal 24) that is substantially the same as the complex impedance of the tag antenna 17 to ensure proper power transfer from the tag antenna 17 to the tag circuit 20 (e.g., in accordance with the “maximum power transfer” theory). While matching is a concern for all many types of tags, matching is a particular concern for passive tags as the power received by the tag antenna 17 is used to power the tag circuit 20.

The RFID tag 16 further comprises a shorting device such as a switch 26 coupled at the base of the tag antenna 17 and input terminal 24 of the impedance matching circuit 22. The switch 26 is illustrates as a Field Effect Transistor (FET), but the switch may be any device capable of operating as a switch (e.g., junction transistors, a triode for alternating current (TRIAC) or Varactor diode). The switch 26 is configured to selectively couple the tag antenna to common 28 at the command of the tag circuit 20. In particular, when the RFID tag 16 is communicating to the RFID reader in the form of backscattered radio frequency signals, the tag circuit 20 selectively tunes and de-tunes the tag antenna 17 by selectively coupling the tag antenna 17 to the common 28 through the switch 26. In some embodiments, the impedance matching circuit 22, tag circuit 20 and switch 26 are all manufactured to engage the same substrate, yet in other embodiments the impedance matching circuit 22, tag circuit 20 and switch 22 are individual components electrically coupled together.

Consider now in greater detail communication from the RFID tag 16 to the RFID reader in the form of backscattered communication. When the switch 26 is non-conductive, its impedance is very high (on the order of Mega-Ohms), and therefore the switch in the non-conductive state has very little impact on the impedance matching between the tag antenna 17 and impedance matching circuit 22. Considering the tag antenna 17 and impedance matching circuit 22 in the absorptive state (i.e., switch 26 in the non-conductive state), a reflection coefficient for the tag antenna 17 may take the form:

ρ_{absorptive}=(Z_{A}−Z_{M})/(Z_{A}+Z_{M}) (1)

where ρ_{absorptive} is the reflection coefficient of the tag antenna in the absorptive configuration, Z_{A} is the impedance of the tag antenna and Z_{M} is the parallel combination of the impedance of the impedance matching circuit 22 and the non-conductive impedance of the switch 26. In the ideal case, Z_{A} is precisely the same as Z_{M}, and thus the ρ_{absorptive}=0. In other words, all incident power is absorbed by the antenna. In actual tags having the Z_{A} precisely the same as Z_{M} is difficult to achieve, and so the ρ_{absorptive} is non-zero.

Now consider the situation where the RFID tag 16 is in the reflective state (i.e., switch 26 in the conductive state). The switch 26 and impedance matching circuit 22 are coupled in parallel, and when the switch 26 is conductive the impedance seen by the tag antenna 17 is the parallel combination of the impedance of the impedance matching circuit 22 and conductive impedance of the switch 26. Thus, considering the tag antenna 17 and parallel combination of the impedance matching circuit 22 and switch 26, a reflection coefficient for the tag antenna 17 may take the form:

ρ_{reflective}=(Z_{A}−Z_{MShort})/(Z_{A}+Z_{Mshort}) (2)

where ρ_{reflective} is the reflection coefficient of the tag antenna in the reflective configuration, Z_{A} is the impedance of the tag antenna and Z_{MShort} is the parallel combination of the impedance of the impedance matching circuit 22 and the switch 26 in the conductive case. In the ideal case, the impedance of the switch 26 in the conductive state is zero, and thus ρ_{reflective}=1. In other words, in the ideal case all incident power is reflected by the antenna. In actual tags, the conductive impedance of the switch 26 is non-zero, and thus ρ_{reflective} is less than one.

In order to increase the distance over which backscattered communications may reach, and/or to decrease error rate in transmission, the difference between the absorbed energy and reflected energy should be increased. One indication of the difference between absorbed and reflected energy is the difference between ρ_{reflective} and ρ_{absorptive}. Thus, for purposes of further explanation this specification defines:

Δ_{ρ}=ρ_{reflective}−ρ_{absorptive} (3)

where Δ_{ρ} is the difference in reflection coefficient as between the reflective and absorptive state for a particular values of tag antenna, impedance matching circuit and conductive switch impedances.

The specification now turns to an analysis of Δ_{ρ} with a host of possible tag antenna impedance values. In spite of the fact that most modular antennas (e.g. individual antennas combined with other components) have impedances between 50 Ohms and 75 Ohms, the table below assumes tag antenna impedances spanning from 10 to 377 Ohms (with corresponding impedance of the impedance matching circuit). Moreover, in spite of the fact that transistors used as switches have conductive impedances that range from 20 to 30 Ohms (for field effect transistors (FETs), the conductive impedance is a function of channel width and contact resistance), the table below assumes a conductive impedance of switch 26 to be 10 Ohms, and a non-conductive impedance of switch 26 to be one Mega-Ohm.

TABLE 1

| Z_{A} | Z_{Switch-On} | Z_{M} | Z_{MShort} | ρ_{reflective} | ρ_{absorptive} | Δ_{ρ} | dB₅₀ |
|---|---|---|---|---|---|---|---|
| 10 | 10 | 10.0 | 5.0 | 0.333333 | 0.0000050 | 0.333328 | −6.6197 |
| 17 | 10 | 17.0 | 6.29629 | 0.459459 | 0.0000085 | 0.459451 | −3.8324 |
| 25 | 10 | 25.0 | 7.14287 | 0.555556 | 0.0000125 | 0.555543 | −2.1828 |
| 50 | 10 | 50.0 | 8.33333 | 0.714286 | 0.0000250 | 0.714261 | 0.00000 |
| 75 | 10 | 75.0 | 8.82353 | 0.789474 | 0.0000375 | 0.789436 | 0.8692 |
| 150 | 10 | 150.0 | 9.375 | 0.882653 | 0.0000750 | 0.882278 | 1.8350 |
| 377 | 10 | 376.9 | 9.74160 | 0.949622 | 0.0001885 | 0.949434 | 2.4722 |

As illustrated by the Table 1, when the tag antenna impedance Z_{A} is approximately the same as the conductive impedance of the switch, the difference in reflection coefficient as between the reflective and absorptive state Δ_{ρ} is low. As the antenna impedance under consideration increases, the Δ_{ρ} improves, with the best Δ_{ρ} occurring when the antenna impedance Z_{A} is 377 Ohms.

The right-most column of Table 1 defines, using the various parameters within the table, performance in decibels (dB) referenced to use of 50 Ohm antenna (hence dB₅₀). Thus, in the row where the antenna impedance is 50 Ohms, the dB₅₀ value is 0.0000. As the difference in reflection coefficient grows smaller (i.e., as the antenna impedance approaches the conductive impedance of the switch), performance degrades, with an illustrative −6.6197 dB difference in performance between the 50 Ohm antenna impedance case and the 10 ohm antenna impedance case. Likewise, as the difference in reflection coefficient grows larger (i e., as the antenna impedance grows larger in relation to the conductive impedance of the switch), performance improves, with an illustrative 2.472 dB difference in performance between the 50 Ohm antenna impedance case and the 377 Ohm antenna impedance case. There thus exists a 9.0918 dB difference in performance between a 10 Ohm antenna and a 377 Ohm antenna when a switch with a conductive impedance of 10 Ohms is used.

Consider now an analysis of Δ_{ρ} with antenna impedance values spanning 10 to 377 Ohms, but with the conductive impedance of the switch being one Ohm, as illustrated in Table 2 below.

TABLE 2

| Z_{A} | Z_{Switch-On} | Z_{M} | Z_{MShort} | ρ_{reflective} | ρ_{absorptive} | Δ_{ρ} | dB₅₀ |
|---|---|---|---|---|---|---|---|
| 10 | 1 | 10.0 | 0.90909 | 0.833333 | 0.0000050 | 0.83328 | −1.2428 |
| 17 | 1 | 17.0 | 0.94444 | 0.894737 | 0.0000085 | 0.894728 | −0.6253 |
| 25 | 1 | 25.0 | 0.96154 | 0.925926 | 0.0000125 | 0.925913 | −0.3277 |
| 50 | 1 | 50.0 | 0.98039 | 0.961538 | 0.0000250 | 0.961513 | 0.00000 |
| 75 | 1 | 75.0 | 0.98684 | 0.974026 | 0.0000375 | 0.973988 | 0.1120 |
| 150 | 1 | 150.0 | 0.99377 | 0.986842 | 0.0000750 | 0.986767 | 0.2252 |
| 377 | 1 | 376.9 | 0.99735 | 0.994723 | 0.0001885 | 0.994534 | 0.2933 |

Much like the illustration of Table 1, Table 2 shows that as the antenna impedance under consideration increases, the Δ_{ρ} improves, with the best Δ_{ρ} occurring when the antenna impedance Z_{A} is 377 Ohms; however, the span of the differences in reflection coefficient as between Table 1 and Table 2 is much smaller. Similarly, considered in reference to performance of the 50 Ohm antenna case, there thus exists a 1.5361 dB difference in performance between a 10 Ohm antenna and a 377 Ohm antenna when a switch with a conductive impedance of one Ohm is used.

A comparison of Table 1 and Table 2 leads to a conclusion that better performance in backscatter communication (e.g., distance of communication, error rate) can be achieved as the difference between the antenna impedance and the conductive impedance of the switch is increased. Consider now an analysis of Δ_{ρ} with antenna impedance values spanning 10 to 377 Ohms, but with the conductive impedance of the switch being 0.1 Ohm, as illustrated in Table 3 below.

TABLE 3

| Z_{A} | Z_{Switch-On} | Z_{M} | Z_{MShort} | ρ_{reflective} | ρ_{absorptive} | Δ_{ρ} | dB₅₀ |
|---|---|---|---|---|---|---|---|
| 10 | 0.1 | 10.0 | 0.09901 | 0.980392 | 0.0000050 | 0.980387 | −0.1372 |
| 17 | 0.1 | 17.0 | 0.09942 | 0.988372 | 0.0000085 | 0.988364 | −0.0668 |
| 25 | 0.1 | 25.0 | 0.09960 | 0.992063 | 0.0000125 | 0.992051 | −0.0344 |
| 50 | 0.1 | 50.0 | 0.09980 | 0.996016 | 0.0000250 | 0.995991 | 0.00000 |
| 75 | 0.1 | 75.0 | 0.09987 | 0.997340 | 0.0000375 | 0.997303 | 0.0114 |
| 150 | 0.1 | 150.0 | 0.09933 | 0.998668 | 0.0000750 | 0.998593 | 0.0227 |
| 377 | 0.1 | 376.9 | 0.09997 | 0.999470 | 0.0001885 | 0.999281 | 0.0286 |

Much like the illustrations of Tables 1 and 2, Table 3 shows that as the antenna impedance under consideration increases, the Δ_{ρ} improves, with the best Δ_{ρ} occurring when antenna impedance Z_{A} is 377 Ohms; however, the span of the differences in reflection coefficient as between previous tables and Table 3 is much smaller. Similarly, considered in reference to performance of the 50 Ohm antenna case, there thus exists a 0.1658 dB difference in performance between a 10 Ohm antenna and a 377 Ohm antenna when a switch with a conductive impedance of 0.1 Ohms is used.

Again, a comparison of the tables leads to the conclusion that better performance in backscatter communication (e.g. distance of communication, error rate) can be achieved as the difference between the antenna impedance and the conductive impedance of the switch is increased; however, the analysis also leads to another surprising result—with a properly selected conductive impedance of the switch 26, the antenna impedance is immaterial to tag performance, as long as the antenna tuned during the absorptive state (i.e., when the switch 26 is open).

Consider again the range of possibilities illustrated by Table 3, with the conductive impedance of the switch 26 being 0.1 Ohm. Whether the tag antenna 17 (and impedance matching circuit 22) has impedance of 10 Ohms, 377 Ohms or anywhere in between, with a conductive impedance of 0.1 Ohms of switch 26 the tag performance is does not exceed 0.1 dB difference in performance relative to the 50 Ohm case. This surprising result frees the tag designer, particularly the designer of the tag antenna 17, to design an antenna without constraint regarding the final impedance of the antenna. Stated otherwise, the tag antenna can be designed to meet any physical requirement (e.g. dimensional constraints or particular radiation pattern) without regard to the impedance of the final design. Once the antenna design is complete, the matching circuit is designed to substantially match the impedance of the antenna during the absorptive state (i.e., switch 26 open), and the conductive impedance of the switch 26 is selected to ensure proper performance of the tag.

As illustrated by the discussion above, the conductive impedance of the switch 26 to achieve a RFID tag whose tag antenna impedance should be immaterial to tag performance varies with varying tag antenna impedance. In most cases, when a difference between a reflection coefficient of the tag antenna when the shorting device is conductive and a reflection coefficient of the tag antenna when shorting device is non-conductive (i e., Δ_{ρ}) is greater than or equal to approximately 0.8, the benefits are utilized. Considered from another perspective, when the tag antenna impedance is more than approximately four (4) times the conducting impedance of the switch, certain of the benefits of the discovery described herein have been utilized.

Returning to FIG. 2, as stated above most transistors have conductive impedances that range from 20 to 30 Ohms. Thus, a RFID tag 16 using a single illustrative FET as in FIG. 2 may only achieve the benefits of the discovery of this specification for relatively high tag antenna impedance values. As the tag antenna impedance decreases, the conductive state impedance may be reduced by utilizing a shorting device comprising a plurality of transistors in parallel. FIG. 3 illustrates embodiments utilizing a switch system 30 comprising two transistors 26A and 26B coupled in parallel to lower the overall conductive impedance of the switch system 30. While FIG. 3 illustrates the switch system 30 as comprising FETs, the switch system 30 may comprise other devices such as junction transistors, TRIACs and Varactor diodes.

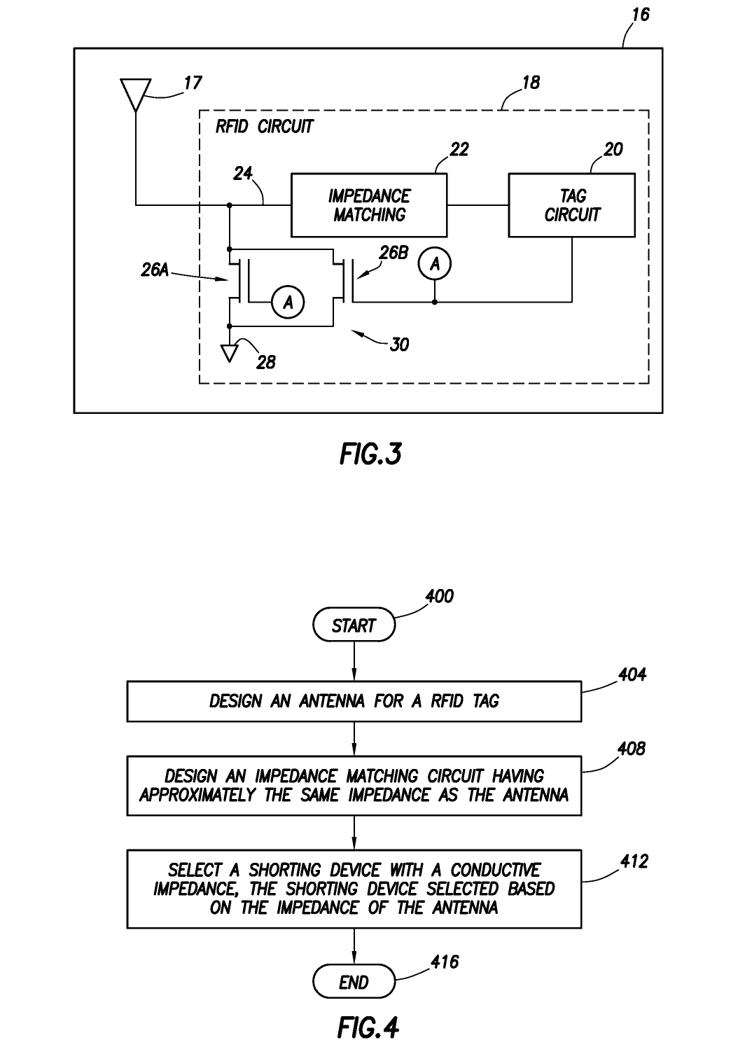

FIG. 4 illustrates a method in accordance with at least some embodiments. In particular, the method starts (block 400) and proceeds to designing an antenna for a RFID tag (block 404). In accordance with the various embodiments, the antenna may be designed where the physical characteristics of the antenna are selected independent of effects of the physical characteristic on impedance of the antenna. Stated otherwise, the design can be formulated without regard to the effect that any particular design decision (antenna physical dimension, radiation pattern) has on the final impedance of the antenna. Once the antenna design is complete enough to calculate or determine an impedance of the antenna, an impedance matching circuit is designed having approximately the same impedance as the antenna (block 408). Finally, a shorting device with a conductive impedance is selected, the shorting device selected based on the impedance of the antenna (block 412), and the illustrative method ends (block 416).

The above discussion is meant to be illustrative of the principles and various embodiments of the present invention. Numerous variations and modifications will become apparent to those skilled in the art once the above disclosure is fully appreciated. For example, though the specification is directed to RFID systems and RFID tags, the various discoveries are beneficial for any type of radio frequency transceiver that uses backscatter as the mechanism to transmit data. It is intended that the following claims be interpreted to embrace all such variations and modifications.

What is claimed is:

1. A radio frequency identification (RFID) tag comprising:
a tag antenna;
a matching circuit coupled to the tag antenna;
a shorting device coupled to the tag antenna and the matching circuit, wherein conductivity of the shorting device affects a reflection coefficient of the tag antenna; and
a tag circuit coupled to the matching circuit and the shorting device, the tag circuit configured to control the shorting device;
wherein a difference between a reflection coefficient of the tag antenna when the shorting device is conductive and a reflection coefficient of the tag antenna when the shorting device is non-conductive is greater than or equal to approximately 0.8.

2. The RFID tag according to claim 1 wherein the difference is greater than or equal to 0.9.

3. The RFID tag according to claim 1 wherein the shorting device further comprises a field effect transistor (FET).

4. The RFID tag according to claim 3 wherein the FET is engages a same substrate as the matching circuit.

5. The RFID tag according to claim 3 wherein the shorting device comprises a plurality of FETs in parallel.

6. The RFID tag according to claim 1 wherein the shorting device further comprises a junction transistor.

7. The RFID tag according to claim 6 wherein the junction transistor engages the same substrate as the matching circuit.

8. The RFID tag according to claim 6 wherein the shorting device comprises a plurality of junction transistors in parallel.

9. The RFID tag according to claim 1 further comprising a power source coupled to the tag circuit.

10. A radio frequency identification (RFID) tag comprising:
a tag antenna;
a matching circuit coupled to the tag antenna;
a tag circuit coupled to the tag antenna through the matching circuit; and
a switch configured to selectively couple the tag antenna to a common potential;
wherein an impedance of the antenna is more than approximately four (4) times a conducting impedance of the switch.

11. The RFID tag according to claim 10 wherein the antenna impedance is more than approximately six (6) times the conducting impedance of the switch.

12. The RFID tag according to claim 10 wherein the antenna impedance is more than approximately eight (8) times the conducting impedance of the switch.

13. The RFID tag according to claim 10 wherein the matching circuit, tag circuit and switch engage a same substrate.

14. The RFID tag according to claim 10 wherein the matching circuit and tag circuit engage the same substrate.

15. The RFID tag according to claim 10 wherein the switch further comprises a plurality of switches coupled in parallel.

16. The RFID tag according to claim 10 wherein the switch is one or more selected from the group consisting of: a field effect transistor; a junction transistor; a TRIAC; and a Varactor diode.

17. A method comprising:
designing an antenna for a radio frequency transceiver, wherein physical characteristics of the antenna are selected independent of effects of the physical characteristic on impedance of the antenna; and then
designing an impedance matching circuit having approximately the same impedance as the antenna; and
selecting a shorting device with a conductive impedance, the shorting device selected based on the impedance of the antenna.

18. The method according to claim 17 wherein selecting further comprising selecting a shorting device whose conductive impedance is less than one quarter (¼) of the impedance of the antenna.

19. The method according to claim 17 wherein designing the impedance matching circuit and selecting further comprises designing the impedance matching circuit and shorting device to be on the same substrate.

20. The method according to claim 17 wherein designing the antenna further comprises designing an antenna whose impedance is greater than 100 Ohms.

21. The method according to claim 17 wherein designing the antenna further comprises designing an antenna whose impedance is greater than 200 Ohms.
